(19) United States
(12) Patent Application Publication
(10) Pub. No.: US 2019/0016981 A1
(43) Pub. Date: Jan. 17, 2019

(54) FUEL OIL COMPOSITION AND USE THEREOF

(71) Applicant: Fu-Guan Huang, Taichung City (TW)

(72) Inventor: Fu-Guan Huang, Taichung City (TW)

(21) Appl. No.: 15/990,947

(22) Filed: May 29, 2018

(30) Foreign Application Priority Data
Jul. 17, 2017 (TW) 106123783

(51) Int. Cl. C10L 1/12; C09C 1/48

(52) U.S. Cl. CPC C10L 1/12; C09C 1/48; C10L 2200/0423; C10L 2200/043; C01P 2004/64; C10L 2230/22; C10L 2250/06; C10L 2270/02; C10L 2200/0446

(57) ABSTRACT

Provided is a fuel oil composition comprising a liquid fuel and carbon black with a particle diameter less than 1 micron. The content of the carbon black is from 0.001 wt % to 4 wt % based on the total weight of the liquid fuel. By way of adding carbon black with the particle diameter less than 1 micron, combustion efficiency of the fuel oil composition used in the internal combustion engine is improved, reducing the emissions of the hydrocarbon and carbon monoxide to reduce greenhouse gas production.

### CROSS REFERENCE TO RELATED APPLICATIONS

Pursuant to 35 U.S.C. § 119(a), this application claims the benefits of the priority to Taiwan Patent Application No. 106123783, filed Jul. 17, 2017. The content of the prior application is incorporated herein by its entirety.

### BACKGROUND OF THE INVENTION

### 1. Field of the Invention

The present invention relates to a new fuel oil composition, and more particularly to a fuel oil composition comprising a liquid fuel and carbon black of a particle diameter less than 1 micron and the use of the fuel oil composition.

### 2. Description of the Prior Arts

Current fuel transport vehicles mainly use oil, coal and other traditional fossil fuels. With the development of society and the advance of science and technology, the use of transport vehicles increase rapidly and brings convenience in daily life, but as well as environmental problems. Among them, hydrocarbons (HC), nitrogen oxides (NOₓ), carbon monoxide (CO) and carbon dioxide (CO₂) and other exhaust generated by high-temperature combustion and incomplete combustion of the internal combustion engine in the automobile increase the greenhouse effect leading to global warming, and ultra-fine suspended particles (PM2.5) generated after the combustion deteriorates air quality, as well as endangers human health. In addition, the incomplete combustion of fuel oil leads to carbon deposition phenomenon, which lowers the intake efficiency of the internal combustion engine and aggravates exhaust emissions. The vicious cycle requires human beings to consume more fuel oil, which leads to more exhaust emissions, and thereby causing serious environmental pollution. Therefore, it is necessary to develop a fuel oil with improved combustion efficiency and decreased exhaust emission. In the present related research, Hot-Plate Ignition Probability for Nanoparticle-Laden Diesel Fuel, Tyagi et al. mentions adding metal aluminum, alumina and other metal nanoparticles with different particle sizes in diesel, it is observed that the fuel containing metal nanoparticles has a higher ignition probability than the pure diesel, but the metal component is very unfriendly to the environment.

In addition, Graphene Nanoparticle-Biodiesel Blended Diesel Engine, Vishwajit et al. mentions that the engines using biomass diesel added into expensive graphene nanoparticles can reduce NOx emissions, but it still cannot solve the problems of incomplete combustion and ultra-fine particle emissions, because graphene inertia brings about decline in combustion efficiency and results more hydrocarbons and smoke emission.

### SUMMARY OF THE INVENTION

In view of the above technical problems of foresaid fuel oil composition, the object of the present invention is to provide a new fuel oil composition which not only improves the fuel combustion efficiency but also reduces the smoke emission after combustion, and thereby saving energy and reducing emissions of ultrafine suspended particulates.

Another object of the present invention is to provide a new fuel oil composition which can reduce the emissions of hydrocarbons and carbon monoxide after combustion, so as to reduce the production of greenhouse gases.

Still another object of the present invention is to provide a new fuel oil composition which has a lower cost advantage and can solve the problem of increased manufacturing costs due to the use of expensive materials such as grapheme, and thereby improving the development potential of commercial products.

To achieve the foresaid objectives, the present invention provides a fuel oil composition comprising a liquid fuel and carbon black of a particle diameter less than 1 micron, wherein the content of the carbon black is 0.001 wt % to 4 wt % based on the total weight of the liquid fuel.

Due to the Van der Waals' force of carbon black surface, carbon black is likely to gather into bundles and precipitate in the solution. In accordance with the present invention, the carbon black particles can be stably dispersed and suspended in the liquid fuel by means of, for example, but not limited to, acid wash of the carbon black, addition of a dispersant or a surfactant, ultrasonic vibration, and so on. Preferably, the fuel oil composition further comprises at least one selected from the group consisting of a dispersant, a surfactant and a combination thereof, helping carbon black to be uniformly suspended in the liquid fuel.

For example, the dispersant applicable to the present invention may be, but not limited to, sorbitan oleate, sorbitan trioleate, oleic acid, ammonium salts of aliphatic acid, anionic aliphatic esters, modified polyurethane polymer, and so on.

For example, the interfacial surfactants applicable to the present invention may be, but not limited to, polyethylene glycol, lecithin, hydrogenated castor oil and so on.

Preferably, based on the total weight of the liquid fuel, the content of dispersant is 0.001 wt % to 4 wt %, so that the dispersant helps the carbon black to be dispersed uniformly.

Preferably, the weight ratio of the dispersant to the carbon black is from 0.5 to 2, so that the dispersant helps the carbon black to be dispersed uniformly. More preferably, the weight ratio of the dispersant to the carbon black is from 0.8 to 1.5.

Preferably, the liquid fuel includes at least one selected from the group consisting of diesel, gasoline, kerosene and any combinations thereof. More preferably, the liquid fuel is diesel.

According to the present invention, the diesel may be extracted from crude oil, which contains C₈ to C₂₁ hydrocarbons. Diesel can be divided into light diesel or heavy diesel according to the carbon number.

Besides, gasoline may be also extracted from crude oil, which contains C₄ to C₈ hydrocarbons. The gasoline can be divided into NO.92 unleaded gasoline, NO.95 unleaded gasoline, NO.98 unleaded gasoline, according to the octane number.

In addition, kerosene may also be extracted from crude oil, which contains C₉ to C₁₆ hydrocarbons.

According to the present invention, carbon black belongs to amorphous carbon and has an amorphous structure. It has stronger ability to adsorb impurities than graphite, as well as reactivity. The method of producing carbon black can be divided into thermal decomposition method and incomplete combustion method. The thermal decomposition method can be employed in a furnace for cracking and to produce the carbon black with a larger particle diameter. For example, Medium Thermal (MT) carbon black has a particle diameter of about 250 nm to 350 nm, and Fine Thermal (FT) carbon black has a particle diameter of about 180 nm to 200 nm. Incomplete combustion method can be divided into slot method, light smoke method, oil furnace method, gas furnace method, and so on to obtain carbon black.

In particular, it is preferred that the carbon black has a particle diameter of from 10 nm to 400 nm.

Preferably, the content of the carbon black is from 0.001 wt % to 2.5 wt % based on the total weight of the liquid fuel. Preferably, the content of the carbon black is from 0.001 wt % to 0.6 wt %.

In addition, the present invention additionally provides a use of the fuel oil composition as described above, which is used for internal combustion engines.

In particular, the internal combustion engine includes a spark ignition engine or a compression ignition engine.

On the premise of maintaining the performance of the fuel oil composition, other auxiliary additives such as detergents, lubricants, friction modifiers, combustion accelerators, antioxidants and other additives may be added to the fuel oil composition depending on the use requirements of the fuel oil composition.

### DETAILED DESCRIPTION OF THE PREFERRED EMBODIMENTS

Hereinafter, several specific embodiments of the fuel oil composition of the present invention will be exemplified by several embodiments, and one skilled in the art can easily realize the advantages and effects in accordance with the present invention from the following examples. Various modifications and variations could be made in order to practice or apply the present invention without departing from the spirit and scope of the invention.

In the following embodiment, a direct injection compression-ignition engine is used as a carrier. Before the experiment, air flow is measured by air flow meter. In the experiment, an eddy-current dynamometer is used to carry out the constant load test, and a fuel flowmeter and a cooling tower are also adopted to respectively monitor the fuel oil flow for assuring the constant input power of the engine and to assist the cooling of the water-cooled engine and dynamometer. Besides, the exhaust gas analyzer and smoke meter are used to obtain the amount of hydrocarbons, carbon monoxide, nitrogen oxides, carbon dioxide produced after the combustion of fuel oil, opacity and other data.

Instrument Type

Compression ignition engine: YAMAHA ME200F three-cylinder diesel engine;

Air flowmeter: The electronic air flow meter produced by Teledyne Hastings Instruments;

Fuel oil flowmeter: The mass flow meter with flowmeter controller MASS-2100 produced by SIEMENS;

Exhaust gas analyzer: HORIBA MEXA-584;

Smoke meter: The optical opacity tester MA-200A produced by MegAsia.

Raw Material

Carbon black: the carbon black purchased from ALL SPRING Company;

Dispersant: Sorbitol monooleate (Span #80);

Diesel: The super diesel from CPC corporation, Taiwan.

### PREPARATION EXAMPLES 1 TO 3

### Fuel Oil Composition

The carbon black was mixed with the dispersant Span #80 in a diesel according to the ratio shown in Table 1 below, and was vibrated by ultrasonic wave, so that the carbon black particles can be well dispersed and the dispersant could be uniformly distributed on the surface of the carbon black particles. After 30 minutes of ultrasonic vibration, semi-finished products were obtained.

Next, the above semi-finished products were pressurized by diesel fuel and filtered through a one-micron pore filter of polypropylene, so as to avoid carbon black larger than one-micron causing the failure of the experiment or nozzle clogging. The fuel oil composition was prepared after the preceding steps.

TABLE 1
Ratio of the fuel oil compositions of Comparative Example 1
and Preparation Examples 1 to 3.

| | Comparative | Preparation | Preparation | Preparation |
|---|---|---|---|---|
| Reagent | Example 1 | Example 1 | Example 2 | Example 3 |
| Diesel (wt %) | 100 | 100 | 100 | 100 |
| Carbon Black (wt %) | 0 | 0.6 | 1.25 | 2.5 |
| Span #80 (wt %) | 0 | 0.48 | 1 | 2 |
| Span #80:carbon | — | 4:5 | | |
| black | | | | |

### TEST EXAMPLE

### Property Analysis Test of the Fuel Oil Composition Used by Diesel Engine

Take the fuel oil composition applied to the diesel engine as an example. The exhaust and smoke emissions between Comparative Example 1 and Preparation Examples 1 to 3, at a specific fuel flow rate (stoichiometric fuel-air ratio is 0.2, 0.3, 0.4, respectively) were analyzed by the same test to compare the differences among the Comparative Examples and Preparation Examples. The results listed in Table 2 to Table 6 are three groups of emission differences measured in the fuel oil composition at the stoichiometric fuel-air ratio of 0.2, 0.3 and 0.4. The results are averaged and shown in Tables 2 to 6 below.

Tables 2 to 6 are the test results at the diesel engine speeds of 1500 rpm, 1800 rpm, 2100 rpm, 2400 rpm, and 2700 rpm, respectively. The fuel oils of Comparative Example 2 and Examples 1 to 3 listed in Table 2 are obtained from the fuel oil compositions of Comparative Example 1 and Preparation Examples 1 to 3 respectively. The fuel oils of Comparative Example 3 and Examples 4 to 6 listed in Table 3 are obtained from the fuel oil compositions of Comparative Example 1 and Preparation Examples 1 to 3 respectively. The fuel oils of Comparative Example 4 and Examples 7 to 9 listed in Table 4 are obtained from the fuel oil compositions of Comparative Example 1 and Preparation Examples 1 to 3 respectively. The fuel oils of Comparative Example 5 and Examples 10 to 12 listed in Table 5 are obtained from the fuel oil compositions of Comparative Example 1 and Preparation Examples 1 to 3 respectively. The fuel oils of Comparative Example 6 and Examples 13 to 15 listed in Table 6 are obtained from the fuel oil compositions of Comparative Example 1 and Preparation Examples 1 to 3 respectively.

Experiment Method

1. Exhaust gas analysis: The original calibration gas was used to calibrate the exhaust gas analyzer before the formal test, so as to ensure that the sensor in the exhaust gas analyzer is in a normal state. The diesel engine is connected with the exhaust gas analyzer through the exhaust pipeline, and the HC, CO, NOx and CO₂ emissions are analyzed simultaneously by the exhaust gas analyzer. Then, on the basis of Comparative Examples 2 to 6, the average emission differences of HC, CO, NOx and CO₂ of fuel oil compositions of Example 1 to Example 15 are calculated, at the fuel flow rates of 0.2, 0.3, and 0.4 and the same speeding rate. The results of the experiment in Table 2 below are taken as an example, combining the average performance of three groups of results measured at the fuel flow rates of 0.2, 0.3, 0.4, respectively; HC, CO, NOx, and CO₂ emissions in Comparative Example 2, which selects the fuel oil composition of Comparative Example 1 as fuel, were set to a base value (set to 0%) at a diesel engine speed of 1500 rpm. In particular, the HC emission of Example 1 was reduced by 41.65% compared with the HC emission of Comparative Example 2, so it was shown as “−41.65%” in Table 2 below; the CO emission of Example 1 was reduced by 51.19% compared with the CO emission of Comparative Example 2, so it was shown as “−51.19%” in Table 2 below; the NOx emission of Example 1 was reduced by 2.84% compared with the NOx emission of Comparative Example 2, so it was shown as “−2.84%” in Table 2 below; the CO₂ emission of Example 1 was reduced by 3.4% compared with the CO₂ emission of Comparative Example 2, so it was shown as “−3.4%” in Table 2 below. Similarly, the emissions of other examples were also compared with the corresponding comparative examples in the manner described above to show the difference in HC, CO, NOx and CO₂ emissions.

2. Opacity measurement: according to “opacity measurement, procedures and emission standards for diesel smoke” certified by ISO 11614, the measuring gun of smoke meter was placed at the flue outlet to measure the opacity. The soot emissions may be obtained in accordance with opacity measurements. The opacity is measured in the range from 0.0 m⁻¹ to 9.9 m ⁻¹. As stated above, on the basis of Comparative Examples 2 to 6, the average soot emission differences of fuel oil compositions of Example 1 to Example 15 are calculated at the fuel flow rates of 0.2, 0.3, and 0.4 and at the same speeding rate. Taking the experiment results of Table 2 below as an example, combine the average performance of three groups of results measured at the fuel flow rates of 0.2, 0.3, 0.4, respectively; soot emission in Comparative Example 2, which selects the fuel oil composition of Comparative Example 1 as fuel, were set to a base value (set to 0%) at a diesel engine speed of 1500 rpm. In particular, the soot emission of Example 1 was reduced by 75.71% compared with the soot emission of Comparative Example 2, so it was shown as “−75.71%” in Table 2 below. Similarly, the soot emissions of other examples were also compared with the corresponding comparative examples in the manner described above to show the difference in soot emissions.

3. Torsion measurement: the torsion is measured by eddy current dynamometer produced by the Italian API company. As stated above, on the basis of Comparative Examples 2 to 6, the average differences of fuel oil compositions of Example 1 to Example 15 are calculated, at the fuel flow rates of 0.2, 0.3, and 0.4 and at the same speeding rate. Taking the experiment results of Table 2 below as an example, combine the average performance of three groups of results measured at the fuel flow rate of 0.2, 0.3, 0.4, respectively; torsion in Comparative Example 2, which selects the fuel oil composition of Comparative Example 1 as fuel, were set to a base value (set to 0%) at a diesel engine speed of 1500 rpm. In particular, the torsion of Example 1 was increased by 0.03% compared with the torsion of Comparative Example 2, so it was shown as “0.03%” in Table 2 below. Similarly, the torsions of other examples were also compared with the corresponding comparative examples in the manner described above to show the difference in torsions.

TABLE 2
Characteristic analysis results of Comparative Example 2 and
Examples 1 to 3 at a diesel engine speed of 1500 rpm.

| | HC | CO | NOx | CO₂ | soot | torsion |
|---|---|---|---|---|---|---|
| Comparative | 0 | 0 | 0 | 0 | 0 | 0 |
| Example 2 | | | | | | |
| Example 1 | −41.65% | −51.19% | −2.84% | −3.4% | −75.71% | 0.03% |
| Example 2 | −36.05% | −21.24% | 12.60% | 1.41% | −28.57% | −4.00% |
| Example 3 | −42.05% | −36.19% | 14.78% | 3.82% | −95.00% | −4.86% |

TABLE 3
Characteristic analysis results of Comparative Example 3 and
Examples 4 to 6 at a diesel engine speed of 1800 rpm.

| | HC | CO | NOx | CO₂ | soot | torsion |
|---|---|---|---|---|---|---|
| Comparative | 0 | 0 | 0 | 0 | 0 | 0 |
| Example 3 | | | | | | |
| Example 4 | −43.13% | −48.72% | −0.60% | −0.96% | −80.37% | 3.39% |
| Example 5 | −48.90% | −30.77% | 7.57% | 4.02% | −31.85% | −0.32% |
| Example 6 | −36.32% | −36.54% | 2.34% | 7.20% | −92.59% | −1.95% |

TABLE 4
Characteristic analysis results of Comparative Example 4 and
Examples 7 to 9 at a diesel engine speed of 2100 rpm.

| | HC | CO | NOx | CO₂ | soot | torsion |
|---|---|---|---|---|---|---|
| Comparative | 0 | 0 | 0 | 0 | 0 | 0 |
| Example 4 | | | | | | |
| Example 7 | −44.74% | −47.46% | −4.23% | −2.95% | −90.28% | −6.02% |
| Example 8 | −41.42% | −44.29% | 9.62% | 0.07% | −30.56% | −6.56% |
| Example 9 | −46.54% | −44.29% | 7.80% | 6.70% | −95.83% | −12.22% |

TABLE 5
Characteristic analysis results of Comparative Example 5 and
Examples 10 to 12 at a diesel engine speed of 2400 rpm.

| | HC | CO | NOx | CO₂ | soot | torsion |
|---|---|---|---|---|---|---|
| Comparative | 0 | 0 | 0 | 0 | 0 | 0 |
| Example 5 | | | | | | |
| Example 10 | −43.53% | −47.73% | −4.50% | 1.45% | −77.86% | −5.39% |
| Example 11 | −38.97% | −41.62% | 4.29% | 3.24% | −38.57% | −3.02% |
| Example 12 | −30.14% | −41.62% | 8.24% | 10.47% | −86.67% | −8.86% |

TABLE 6
Characteristic analysis results of Comparative Example 6 and
Examples 13 to 15 at a diesel engine speed of 2700 rpm.

| | HC | CO | NOx | CO₂ | soot | torsion |
|---|---|---|---|---|---|---|
| Comparative | 0 | 0 | 0 | 0 | 0 | 0 |
| Example 6 | | | | | | |
| Example 13 | −54.55% | −44.16% | 4.93% | −0.45% | −76.62% | −0.65% |
| Example 14 | −35.98% | −29.87% | 17.32% | 3.28% | −40.58% | −1.69% |
| Example 15 | −26.84% | −45.45% | 16.63% | 7.50% | −81.82% | −6.31% |

As shown in Table 2 to Table 6 above, whether at the speed of 1500 rpm representing low speed of the diesel engine, 1800 and 2100 rpm representing moderate speed of the diesel engine, 2400 and 2700 rpm representing high speed of the diesel engine, the soot emissions of Examples 1 to 3, 4 to 6, 7 to 9, 10 to 12, and 13 to 15 were significantly lower than the soot emissions of Comparative Examples 2, 3, 4, 5, and 6 respectively. Thus, it can be seen that the carbon black in the fuel oil composition selected in Example 1 to 3 would be agglomerated into larger blocks when the diesel droplets are vaporized, such that the larger blocks can be the nucleus of the ultrafine suspended particles in the smoke; besides, the porous structure of the carbon black itself can also help capture the ultrafine suspended particles and then the original ultra-fine suspended particles are adsorbed on the block to form a larger block until the block cannot be suspended in the air and sediments. It proves that the use of the fuel oil compositions of Examples 1 to 3 indeed reduces ultrafine suspended particulate emissions produced by combustion, and thereby significantly reducing soot emissions.

As shown in Table 2 to Table 6, the HC and CO emissions produced by the fuel oil compositions of Preparation Examples 1 to 3 used in a diesel engine (Examples 1 to 15), were significantly decreased compared with the fuel oil compositions of Comparative Example 1 used in a diesel engine (Examples 2 to 6), indicating that the use of the fuel oil compositions of Examples 1 to 3 indeed reduces HC and CO emissions after combustion, and thereby reducing the production of greenhouse gases. It is common knowledge that HC and CO are produced by incomplete combustion, the less the HC and CO emissions, the more complete the combustion, so it is concluded that using the fuel oil compositions of the present invention improves the combustion efficiency of the fuel oil and thus saves energy

As shown in Tables 2 to 6, the NO, and CO₂ emissions produced by the fuel oil compositions of Preparation Examples 2 to 3 used in a diesel engine (Examples 2, 3, 5, 6, 8, 9, 11, 12, 14, 15), were slightly increased compared with the fuel oil compositions of Comparative Example 1 used in a diesel engine (Comparative Examples 2 to 6), indicating that the fuel oil compositions of Preparation Examples 2 to 3 have a tendency of combustion concentration and thus are useful to improve the combustion efficiency of the fuel oil.

As shown in Tables 2 to 6, although a slight decrease of torque is observed in Examples 2, 3, 5 to 15, the range of decrease is still within an acceptable range and thus does not affect the normal operation of the engine. Besides, selecting the fuel oil composition of Preparation Example 1 is more beneficial to increase the torque of the diesel engine under low load, so the torques of Examples 1 and 4 are higher than those of Comparative Examples 2 and 3, respectively.

According to the above analysis, by way of adding carbon black of a particle diameter less than 1 micron, the present invention specifically improves combustion efficiency of the fuel oil composition used in the internal combustion engine, reduces the emissions of the hydrocarbon and carbon monoxide to reduce greenhouse gas production, and raises developmental potential of the fuel oil composition in the invention, because carbon black has a lower cost, higher reactivity compared with other material such as grapheme.

What is claimed is:

1. A fuel oil composition comprising: a liquid fuel and carbon black with a particle diameter less than 1 micron, wherein the content of the carbon black is 0.001 wt % to 4 wt % based on the total weight of the liquid fuel.

2. The fuel oil composition as claimed in claim 1, wherein the fuel oil composition further comprises at least one selected from the group consisting of a dispersant, a surfactant and a combination thereof.

3. The fuel oil composition as claimed in claim 2, wherein the content of the dispersant is from 0.001 wt % to 4 wt % based on the total weight of the liquid fuel.

4. The fuel oil composition as claimed in claim 2, wherein the weight ratio of the dispersant to the carbon black is 0.5 to 2.

5. The fuel oil composition as claimed in claim 1, wherein the liquid fuel includes at least one selected from the group consisting of diesel, gasoline, kerosene and a combination thereof.

6. The fuel oil composition as claimed in claim 2, wherein the liquid fuel includes at least one selected from the group consisting of diesel, gasoline, kerosene and a combination thereof.

7. The fuel oil composition as claimed in claim 1, wherein the particle diameter of the carbon black is 10 nm to 400 nm.

8. The fuel oil composition as claimed in claim 2, wherein the particle diameter of the carbon black is 10 nm to 400 nm.

9. The fuel oil composition as claimed in claim 3, wherein the particle diameter of the carbon black is 10 nm to 400 nm.

10. The fuel oil composition as claimed in claim 4, wherein the particle diameter of the carbon black is 10 nm to 400 nm.

11. The fuel oil composition as claimed in claim 5, wherein the particle diameter of the carbon black is 10 nm to 400 nm.

12. The fuel oil composition as claimed in claim 1, wherein the content of the carbon black is from 0.001 wt % to 2.5 wt % based on the total weight of the liquid fuel.

13. The fuel oil composition as claimed in claim 2, wherein the content of the carbon black is from 0.001 wt % to 2.5 wt % based on the total weight of the liquid fuel.

14. The fuel oil composition as claimed in claim 3, wherein the content of the carbon black is from 0.001 wt % to 2.5 wt % based on the total weight of the liquid fuel.

15. The fuel oil composition as claimed in claim 4, wherein the content of the carbon black is from 0.001 wt % to 2.5 wt % based on the total weight of the liquid fuel.

16. The fuel oil composition as claimed in claim 5, wherein the content of the carbon black is from 0.001 wt % to 2.5 wt % based on the total weight of the liquid fuel.

17. The fuel oil composition as claimed in claim 11, wherein the content of the carbon black is from 0.001 wt % to 2.5 wt % based on the total weight of the liquid fuel.

18. A use of the fuel oil composition as claimed in claim 1, wherein the fuel oil composition is used for internal combustion engines.

19. The use as claimed in claim 18, wherein the internal combustion engines include spark ignition engines or compression ignition engines.
